(19) United States
(12) Patent Application Publication
(10) Pub. No.: US 2014/0218413 A1
(43) Pub. Date: Aug. 7, 2014

(54) PIXEL AND DRIVING METHOD THEREOF

(71) Applicant: AU Optronics Corp., Hsin-Chu (TW)

(72) Inventors: Fang-Cheng Yu, Hsin-Chu (TW); Szu-Yu Lin, Hsin-Chu (TW); Cheng-Yeh Tsai, Hsin-Chu (TW)

(73) Assignee: AU Optronics Corp., Hsin-Chu (TW)

(21) Appl. No.: 13/950,306

(22) Filed: Jul. 25, 2013

(30) Foreign Application Priority Data
Feb. 5, 2013 (TW) 102104362

(51) Int. Cl. G09G 3/36; G02F 1/1343

(52) U.S. Cl. CPC G09G 3/3648; G02F 1/134309
USPC 345/690; 349/139; 345/88

(57) ABSTRACT

A pixel includes a first electrode, a second electrode and a third electrode. The first electrode and the second electrode are formed on a lower substrate. The third electrode is formed on an upper substrate and above a position between the first and second electrodes. Liquid crystals are formed between the upper and lower substrates. A method for driving the pixel includes providing a first data voltage to the first electrode, providing a second data voltage to the second electrode, and providing a common voltage to the third electrode. The common voltage is substantially the mean value of the first and second data voltages.

### BACKGROUND OF THE INVENTION

1. Field of the Invention

The present invention relates to a pixel and a driving method, and more particularly, to a pixel and a driving method capable of increasing phase difference between electrodes as well as increasing transmittance of liquid crystals.

2. Description of the Prior Art

Because a liquid crystal display (LCD) and a light emitting diode (LED) display have advantages of thin appearance, low power consumption, and low radiation, the liquid crystal display and the light emitting diode display have been widely applied in various electronic products, such as multimedia players, mobile phones, personal digital assistants (PDA), PC monitors, or flat TVs.

In order to decrease response time of LCD, blue phase liquid crystal has been disclosed. The blue phase liquid crystal is between an isotropic phase and a chlosteric phase, and needs to be driven by horizontal electric field generated by in-plane switch (IPS) electrodes. An IPS panel has advantages of wide viewing angle, short response time, and accurate color reproduction. But under an IPS driving mode, the liquid crystals have a disadvantage of low transmittance due to effective range of horizontal electric field is too small, such that phase difference between electrodes is insufficient. The blue phase liquid crystals also have the same problem when using the IPS electrodes.

### SUMMARY OF THE INVENTION

An embodiment of the present invention discloses a driving method of a pixel, the pixel comprises a first electrode, a second electrode and a third electrode, the first electrode and the second electrode are formed on a lower substrate, the third electrode is formed on an upper substrate and above a position between the first and second electrodes, and liquid crystals are formed between the upper and lower substrates. The driving method comprises providing a first data voltage to the first electrode; providing a second data voltage to the second electrode; and providing a common voltage to the third electrode. The common voltage is substantially a mean value of the first and second data voltages.

Another embodiment of the present invention discloses a driving method of a pixel, the pixel comprises a first electrode, a second electrode and a third electrode, the first electrode and the second electrode are formed on a lower substrate, the third electrode is formed on an upper substrate and above a position between the first and second electrodes, and liquid crystals are formed between the upper and lower substrates. The driving method comprises providing a first data voltage to the first electrode; providing a first common voltage to the second electrode; and providing a first mean voltage substantially equal to a mean value of the first data voltage and the first common voltage to the third electrode. The first mean is lower than the first data voltage.

Another embodiment of the present invention discloses a pixel, comprising an upper substrate, a lower substrate, a first electrode, a second electrode, and a third electrode. Liquid crystals are formed between the upper and lower substrates. The first electrode is formed on the lower substrate, for providing a first data voltage in an Nth frame, and providing a third data voltage in an (N+1)th frame. The second electrode is formed on the lower substrate, for providing a second data voltage in the Nth frame, and providing a fourth data voltage in the (N+1)th frame. The third electrode is formed on the upper substrate and above a position between the first and second electrodes, for providing a common voltage. The common voltage is identical in the Nth frame and the (N+1)th frame, the common voltage is substantially a mean value of the first and second data voltages, the common voltage is substantially a mean value of the third and fourth data voltages, the first and fourth data voltages are higher than the common voltage, the second and third data voltages are lower than the common voltage, and N is a positive integer.

Another embodiment of the present invention discloses a pixel, comprising an upper substrate, a lower substrate, a first electrode, a second electrode, and a third electrode. Liquid crystals are formed between the upper and lower substrates. The first electrode is formed on the lower substrate, for providing a first data voltage in an Nth frame, and providing a second data voltage in an (N+1)th frame. The second electrode is formed on the lower substrate, for providing a first common voltage in the Nth frame, and providing a second common voltage in the (N+1)th frame. The third electrode is formed on the upper substrate and above a position between the first and second electrodes, for providing a first mean voltage substantially equal to a mean value of the first data voltage and the first common voltage in the Nth frame, and providing a second mean voltage substantially equal to a mean value of the second data voltage and the second common voltage in the (N+1)th frame. The first common voltage is lower than the first data voltage, the second common voltage is higher than the second data voltage, and N is a positive integer.

Through arrangements of the embodiments of the present invention, effective range of horizontal electric field in the pixel can be greatly increased, for increasing phase difference between electrodes in the pixel as well as increasing transmittance of the liquid crystals. In addition, in the embodiments of the present invention, the liquid crystals can be replaced by blue phase liquid crystals. Therefore, through the present invention, a problem of insufficient phase difference between electrodes in the pixel caused by the blue phase liquid crystals operating under an IPS mode can be solved, so as to increase transmittance of the blue phase liquid crystals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a pixel of a first embodiment of the present invention.

FIG. 2 is a timing diagram of providing data signals to the pixel 100 of FIG. 1.

FIG. 3 is a diagram showing a circuit of the pixel of FIG. 1.

FIG. 4 is a diagram showing scale of the pixel of FIG. 1.

FIG. 5 is a flowchart showing a driving method of the pixel of the present invention.

FIG. 6 is a diagram showing a pixel of a second embodiment of the present invention.

FIG. 7 is a timing diagram of providing data signals to the pixel of FIG. 6.

FIG. 8 is a diagram showing a circuit of the pixel of FIG. 6.

FIG. 9 is a flowchart showing another driving method of the pixel of the present invention.

### DETAILED DESCRIPTION

The detailed descriptions of the present invention are exemplified below in examples. However, the examples are merely used to illustrate the present invention, not to limit the present invention. Because one skilled in the art may modify the present invention or combine the present invention with some features within the scope of the present invention, the claimed scope of the present invention should be referred to in the following claims. In the present specification and claims, the term “comprising” is open type and should not be viewed as the term “consisted of.” Besides, the term “electrically coupled” can be referring to either directly connecting or indirectly connecting between elements. Thus, if it is described in the below contents of the present invention that a first device is electrically coupled to a second device, the first device can be directly connected to the second device, or indirectly connected to the second device through other devices or means.

The embodiments and figures are provided as follows in order to illustrate the present invention in detail, but the claimed scope of the present invention is not limited by the provided embodiments and figures. Further, the numbers of steps performed in the methods of the present invention are not used to limit the priority of performing steps of the present invention. Any methods formed by recombining the steps of the present invention belong to the scope of the present invention.

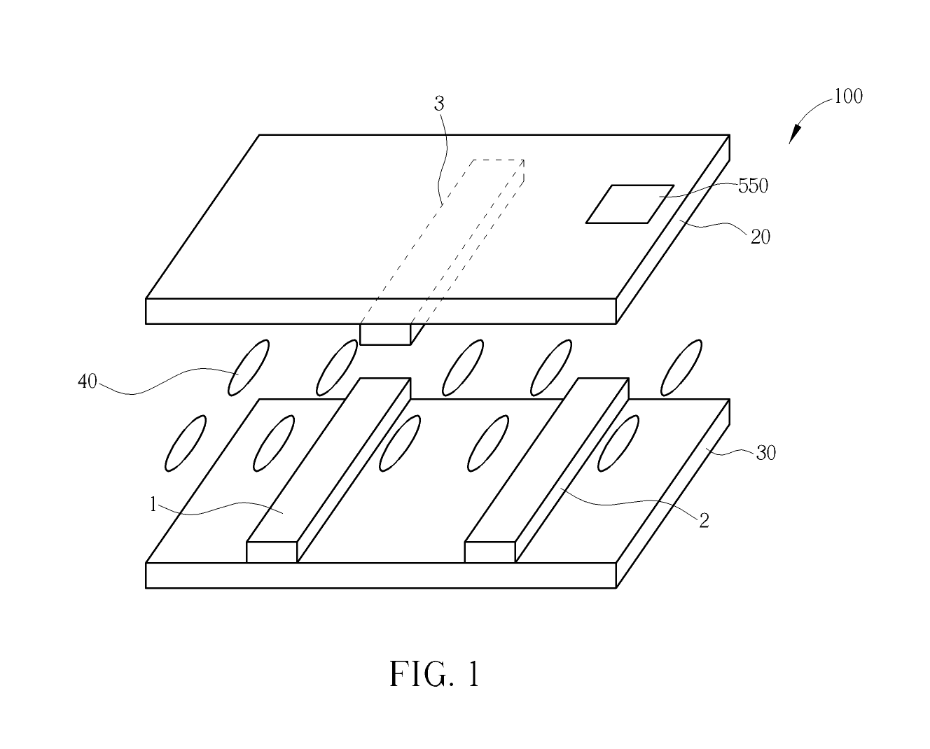

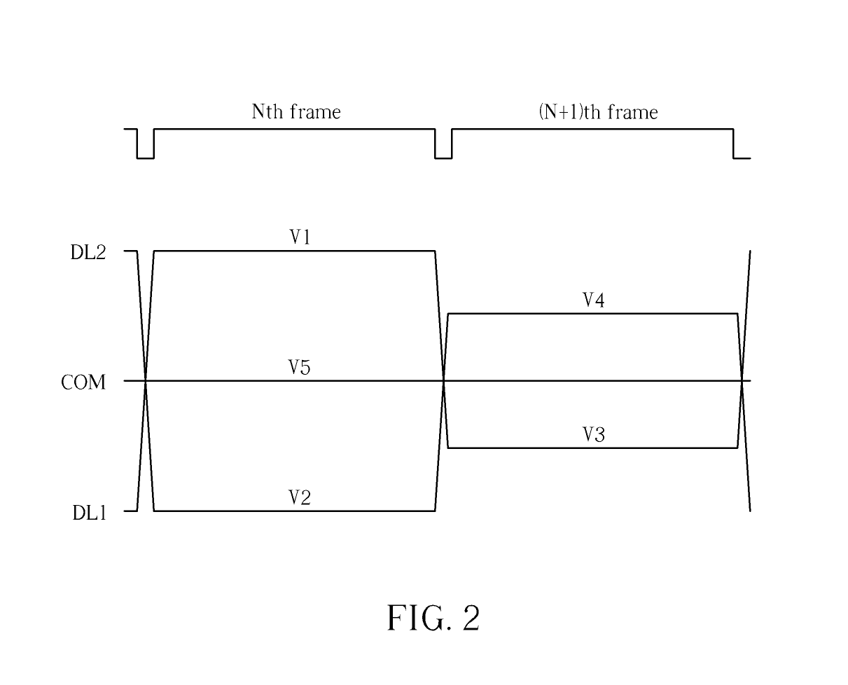

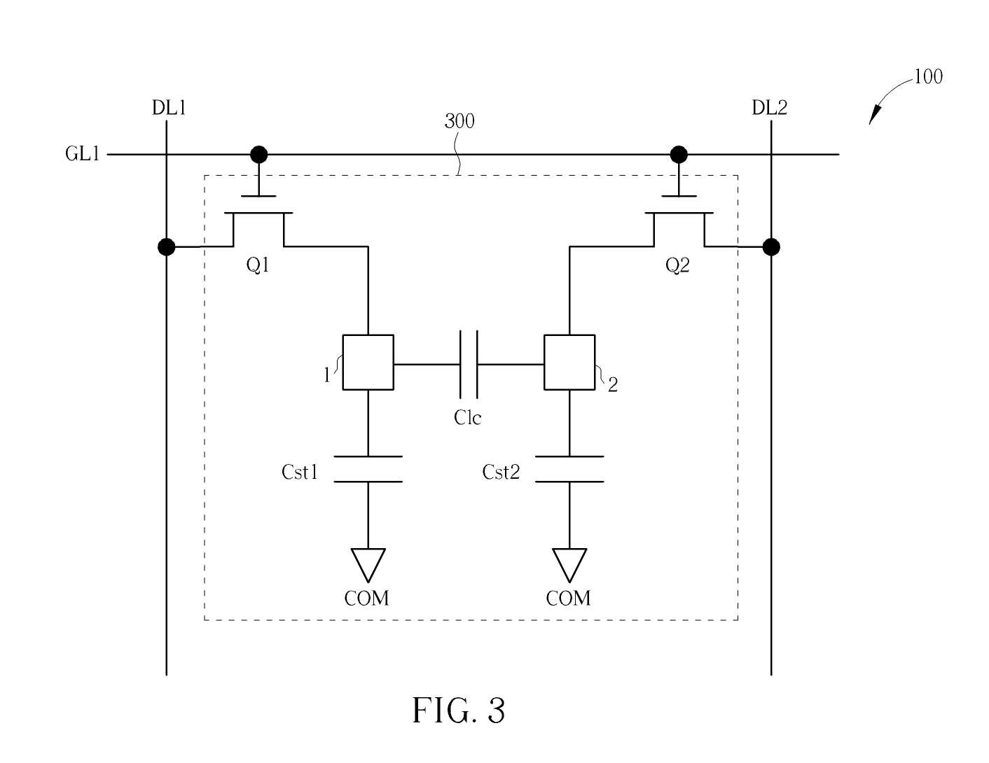

Please refer to FIG. 1, FIG. 2, and FIG. 3. FIG. 1 is a diagram showing a pixel 100 of a first embodiment of the present invention. FIG. 2 is a timing diagram of providing data signals to the pixel 100 of FIG. 1. FIG. 3 is a diagram showing a circuit of the pixel 100 of FIG. 1. As shown in FIG. 1 and FIG. 2, the pixel 100 comprises an upper substrate 20, a lower substrate 30, a first electrode 1, a second electrode 2, and a third electrode 3. Liquid crystals 40 are formed between the upper substrate 20 and the lower substrate 30, and the upper substrate 20 comprises a color filter 550. The first electrode 1 is coupled to a first data line DL1 for receiving a data voltage transmitted by the first data line DL1. The second electrode 2 is coupled to a second data line DL2 for receiving a data voltage transmitted by the second data line DL2. The third electrode 3 is coupled to a common voltage source COM for receiving a common voltage provided by the common voltage source COM.

The first electrode 1 is formed on the lower substrate 30 for providing a first data voltage V1 in an Nth frame, and providing a third data voltage V3 in an (N+1)th frame. The second electrode 2 is formed on the lower substrate 30 for providing a second data voltage V2 in the Nth frame, and providing a fourth data voltage V4 in the (N+1)th frame. The third electrode 3 is formed on the upper substrate 20 and above a position between the first electrode 1 and the second electrode 2, for providing a common voltage V5. As shown in FIG. 2, the common voltage V5 is identical in the Nth frame and the (N+1)th frame, the common voltage V5 is substantially a mean value of the first data voltage V1 and the second data voltage V2, and the common voltage V5 is also substantially a mean value of the third data voltage V3 and the fourth data voltage V4. In addition, the first and fourth data voltages V1, V4 are higher than the common voltage V5, the second and third data voltages V2, V3 are lower than the common voltage V5, and N is a positive integer.

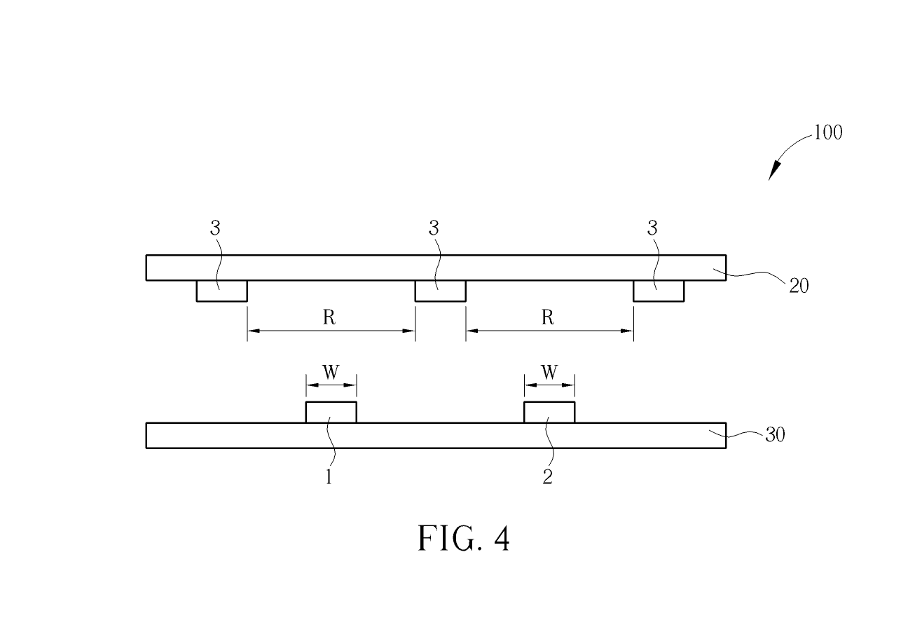

Please refer to FIG. 4. FIG. 4 is a diagram showing scale of the pixel 100 of FIG. 1. As shown in FIG. 4, each two adjacent third electrodes 3 are separated by an interval R, and each of the first and second electrodes 1, 2 has a width W. A preferred ratio between the interval R and the width W is 5W≧R≧1.5W, but the present invention is not limited to the above, for example, the first and second electrodes 1, 2 can have different widths, and the ratio between the interval R and the width W can be different from the above ratio.

IN FIG. 3, the pixel 100 comprises a pixel unit 300, the pixel unit 300 comprises a first switch Q1, a second switch Q2, a liquid crystal capacitor Clc, a first storage capacitor Cst1 and a second storage capacitor Cst2. A first end of the first switch Q1 is coupled to the first data line DL1, a control end of the first switch Q1 is coupled to a first gate line GL1 for being turned on/off according to a voltage level of the first gate line GL1, and a second end of the first switch Q1 is coupled to the first electrode 1. The first electrode 1 is coupled to the liquid crystal capacitor Clc and the first storage capacitor Cst1. A first end of the second switch Q2 is coupled to the second electrode 2, a control end of the second switch Q2 is coupled to the first gate line GL1 for being turned on/off according to the voltage level of the first gate line GL1, and a second end of the second switch Q2 is coupled to the second data line DL2. The second electrode 2 is coupled to the liquid crystal capacitor Clc and the second storage capacitor Cst2. When the first switch Q1 and the second switch Q2 are turned on, the first switch Q1 and the second switch Q2 respectively receive signals transmitted from the first data line DL1 and the second data line DL2. In addition, the first storage capacitor Cst1 is configured to store the signal transmitted from the first data line DL1, and the second storage capacitor Cst2 is configured to store the signal transmitted from the second data line DL2.

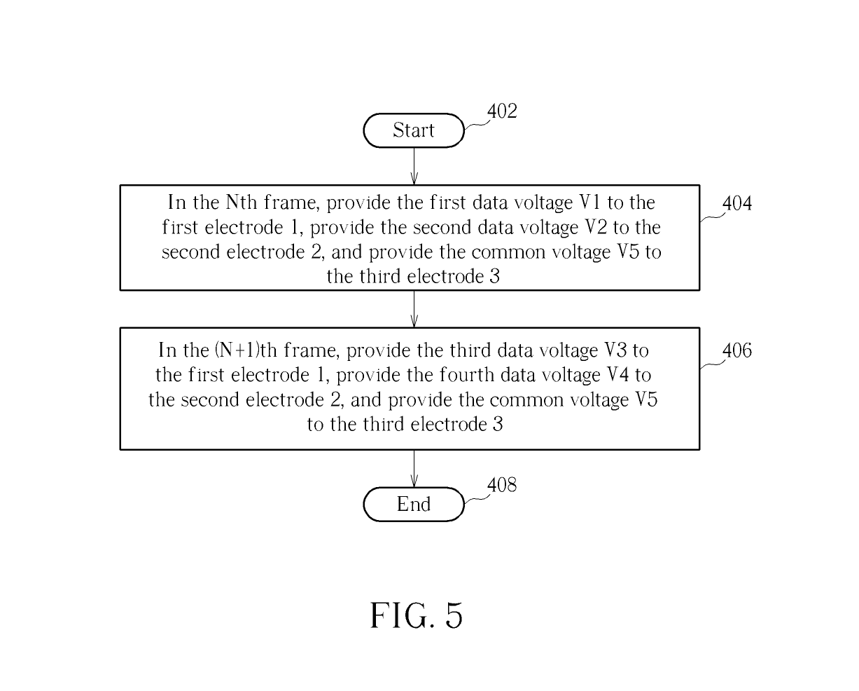

Please refer to FIG. 5. FIG. 5 is a flowchart showing a driving method of the pixel 100 of the present invention. The flowchart comprises the following steps:

Step 402: Start;

Step 404: In the Nth frame, provide the first data voltage V1 to the first electrode 1, provide the second data voltage V2 to the second electrode 2, and provide the common voltage V5 to the third electrode 3;

Step 406: In the (N+1)th frame, provide the third data voltage V3 to the first electrode 1, provide the fourth data voltage V4 to the second electrode 2, and provide the common voltage V5 to the third electrode 3; and

Step 408: End.

In the first embodiment, since the common voltage V5 is substantially a mean value of the first data voltage V1 and the second data voltage V2, that is to say, a voltage level of the common voltage V5 is between a voltage level of the first data voltage V1 and a voltage level of the second data voltage V2. Therefore, electric potential of the third electrode 3 is between electric potential of the first electrode 1 and electric potential of the second electrode 2. According to the above arrangement, oblique electric fields are formed between the third electrode 3 and the first electrode 1, and between the third electrode 3 and the second electrode 2 respectively. In addition, horizontal component of the oblique electric field between the third electrode 3 and the first electrode 1 is in a same direction as horizontal component of the oblique electric field between the third electrode 3 and the second electrode 2. For example, in an Nth frame of a display, the voltage level of the first electrode 1 (that is the first data voltage V1) is higher than the voltage level of the third electrode 3 (that is the common voltage V5), and the voltage level of the second electrode 2 (that is the second data voltage V2) is lower than the voltage level of the third electrode 3 (that is the common voltage V5), therefore, horizontal electric fields in the same direction are formed between the third electrode 3 and the first electrode 1, and between the third electrode 3 and the second electrode 2 respectively. Similarly, in an (N+1)th frame of the display, the voltage level of the first electrode 1 (that is the third data voltage V3) is lower than the voltage level of the third electrode 3 (that is the common voltage V5), and the voltage level of the second electrode 2 (that is the fourth data voltage V4) is higher than the voltage level of the third electrode 3 (that is the common voltage V5), therefore, horizontal electric fields in the same direction are also formed between the third electrode 3 and the first electrode 1, and between the third electrode 3 and the second electrode 2 respectively.

Through the arrangement of the first embodiment of the present invention, since the oblique electric fields are formed between the third electrode 3 and the first electrode 1, and between the third electrode 3 and the second electrode 2 respectively, an effective range of the horizontal electric field in the pixel 100 can be greatly increased, for increasing phase difference between electrodes in the pixel 100 as well as increasing transmittance of the liquid crystals 40. In addition, in the embodiment of the present invention, the liquid crystals 40 in the pixel 100 can be replaced by blue phase liquid crystals. Therefore, through the present invention, a problem of insufficient phase difference between electrodes in the pixel caused by the blue phase liquid crystals operating under an IPS mode can be solved, so as to increase transmittance of the blue phase liquid crystals.

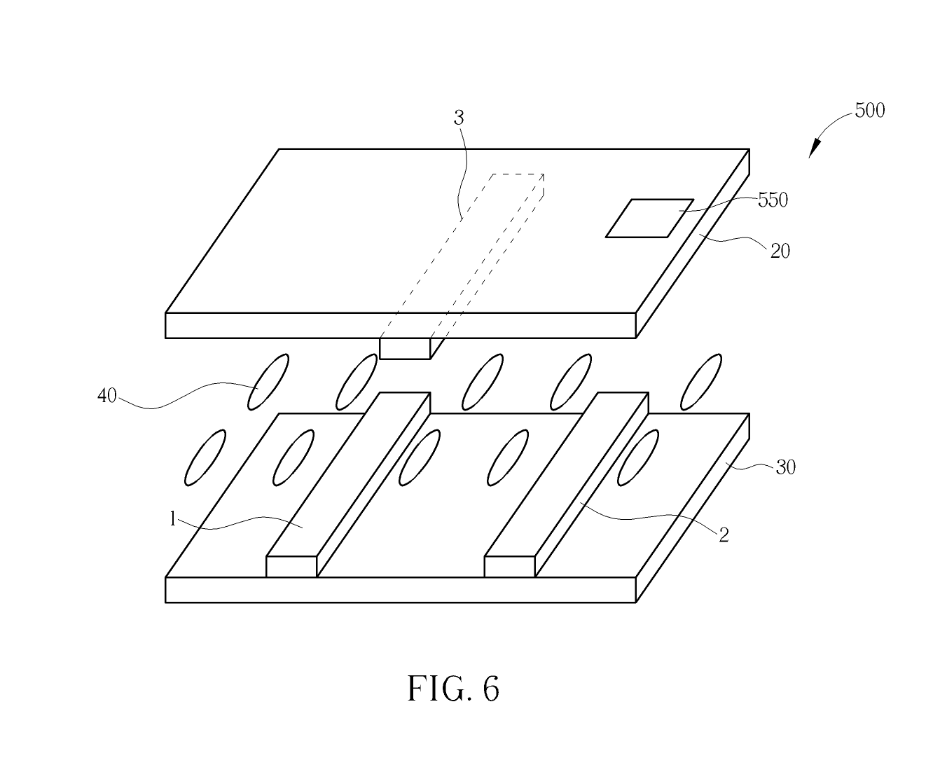

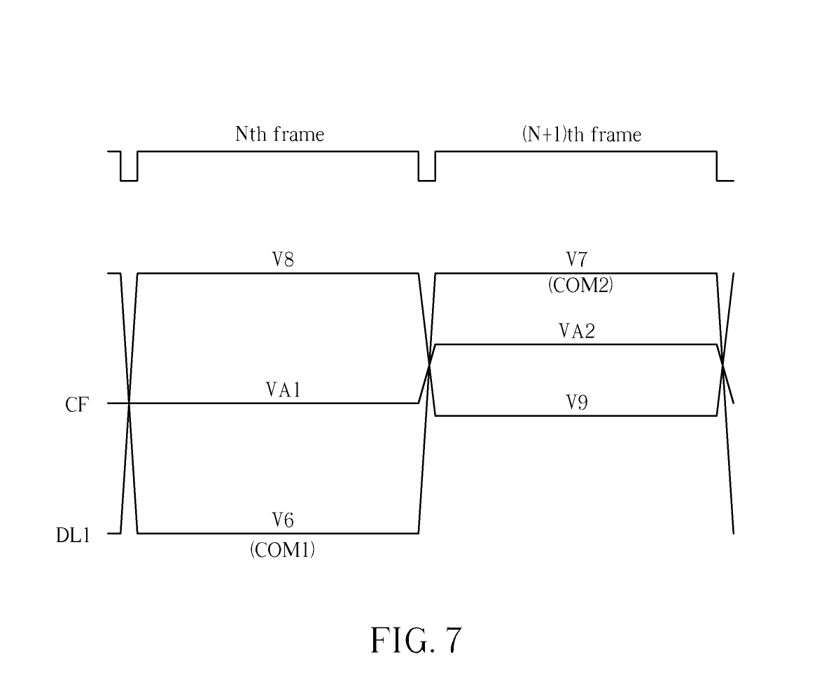

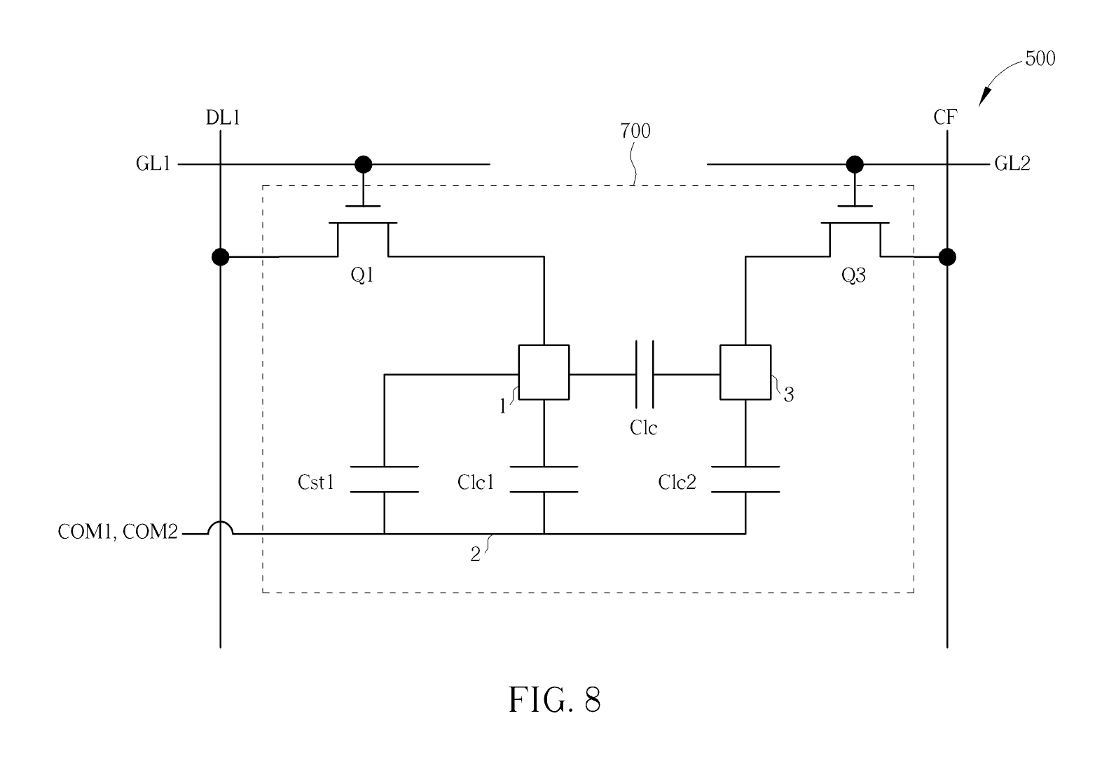

Please refer to FIG. 6, FIG. 7, and FIG. 8. FIG. 6 is a diagram showing a pixel 500 of a first embodiment of the present invention. FIG. 7 is a timing diagram of providing data signals to the pixel 500 of FIG. 6. FIG. 8 is a diagram showing a circuit of the pixel 500 of FIG. 6. Different from the pixel 100, in the pixel 500, the first electrode 1 is coupled to the first data line DL1, the second electrode 2 is coupled to a first common voltage source COM1 providing a first common voltage V6, and coupled to a second common voltage source COM2 providing a second common voltage V7 in a sequence. In addition, the upper substrate 20 comprises a color filter 550. Preferred arrangement of the first electrode 1, the second electrode 2 and the third electrode 3 can refer to FIG. 4, therefore it is not further illustrated.

In the second embodiment, the first electrode 1 is configured to provide a first data voltage V8 in an Nth frame, and providing a second data voltage V9 in an (N+1)th frame. The second electrode 2 is configured to provide the first common voltage V6 in the Nth frame, and provide the second common voltage V7 in the (N+1)th frame. The third electrode 3 is configured to provide the first mean voltage VA1 substantially equal to a mean value of the first data voltage V8 and the first common voltage V6 in the Nth frame, and provide the second mean voltage VA2 substantially equal to a mean value of the second data voltage V9 and the second common voltage V7 in the (N+1)th frame. The first common voltage V6 is lower than the first data voltage V8, the second common voltage V7 is higher than the second data voltage V9, and N is a positive integer.

In FIG. 7, the pixel 500 comprises a pixel unit 700, the pixel unit 700 comprises a first switch Q1, a third switch Q3, a liquid crystal capacitor Clc, a first liquid crystal capacitor Clc1, a second liquid crystal capacitor Clc2, and a first storage capacitor Cst1. A first end of the first switch Q1 is coupled to the first data line DL1, a control end of the first switch Q1 is coupled to a first gate line GL1 for being turned on/off according to a voltage level of the first gate line GL1, and a second end of the first switch Q1 is coupled to the first electrode 1. The first electrode 1 is coupled to the liquid crystal capacitor Clc, the first liquid crystal capacitor Clc1 and the first storage capacitor Cst1. A first end of the third switch Q3 is coupled to the third electrode 3, a control end of the third switch Q3 is coupled to a second gate line GL2 for being turned on/off according to the voltage level of the second gate line GL2, and a second end of the third switch Q3 is coupled to a signal source CF. The third electrode 3 is coupled to the liquid crystal capacitor Clc and the second liquid crystal capacitor Clc2. When the first switch Q1 and the third switch Q3 are turned on, the first switch Q1 and the third switch Q3 respectively receive signals transmitted from the first data line DL1 and the signal source CF. In addition, the first storage capacitor Cst1 is configured to store the signal transmitted from the first data line DL1, the first liquid crystal capacitor Clc1 is coupled between the first electrode 1 and the second electrode 2, and the second liquid crystal capacitor Clc2 is coupled between the third electrode 3 and the second electrode 2.

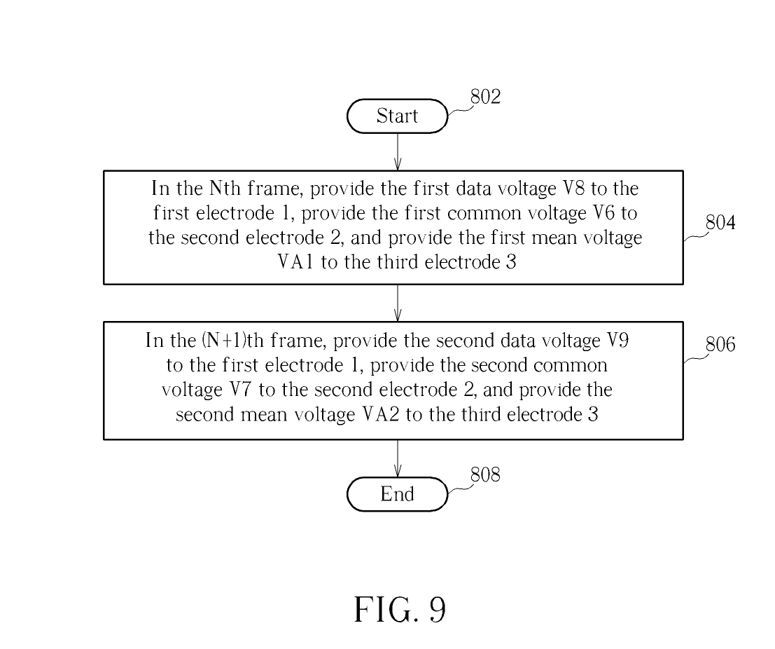

Please refer to FIG. 9. FIG. 9 is a flowchart showing a driving method of the pixel 500 of the present invention. The flowchart comprises the following steps:

Step 802: Start;

Step 804: In the Nth frame, provide the first data voltage V8 to the first electrode 1, provide the first common voltage V6 to the second electrode 2, and provide the first mean voltage VA1 to the third electrode 3;

Step 806: In the (N+1)th frame, provide the second data voltage V9 to the first electrode 1, provide the second common voltage V7 to the second electrode 2, and provide the second mean voltage VA2 to the third electrode 3; and

Step 808: End.

In the second embodiment, since the mean voltage VA1 is substantially a mean value of the first data voltage V8 and the first common voltage V6, that is to say, a voltage level of the first mean voltage VA1 is between a voltage level of the first data voltage V8 and a voltage level of the first common voltage V6. Therefore, electric potential of the third electrode 3 is between electric potential of the first electrode 1 and electric potential of the second electrode 2. According to the above arrangement, oblique electric fields are formed between the third electrode 3 and the first electrode 1, and between the third electrode 3 and the second electrode 2 respectively. In addition, horizontal component of the oblique electric field between the third electrode 3 and the first electrode 1 is in a same direction as horizontal component of the oblique electric field between the third electrode 3 and the second electrode 2. For example, in an Nth frame of a display, the voltage level of the first electrode 1 (that is the first data voltage V8) is higher than the voltage level of the third electrode 3 (that is the first mean voltage VA1), and the voltage level of the second electrode 2 (that is the first common voltage V6) is lower than the voltage level of the third electrode 3 (that is the first mean voltage VA1), therefore, horizontal electric fields in the same direction are formed between the third electrode 3 and the first electrode 1, and between the third electrode 3 and the second electrode 2 respectively. Similarly, in an (N+1)th frame of the display, the voltage level of the first electrode 1 (that is the second data voltage V9) is lower than the voltage level of the third electrode 3 (that is the second mean voltage VA2), and the voltage level of the second electrode 2 (that is the second common voltage V7) is higher than the voltage level of the third electrode (that is the second mean voltage VA2), therefore, horizontal electric fields in the same direction are also formed between the third electrode 3 and the first electrode 1, and between the third electrode 3 and the second electrode 2 respectively.

Through the arrangement of the second embodiment of the present invention, since oblique electric fields are formed between the third electrode 3 and the first electrode 1, and between the third electrode 3 and the second electrode 2 respectively, an effective range of the horizontal electric field in the pixel 500 can be greatly increased, for increasing phase difference between electrodes in the pixel 500 as well as increasing transmittance of the liquid crystals. In addition, in the embodiment of the present invention, the liquid crystals 40 in the pixel 500 can be replaced by the blue phase liquid crystals. Therefore, through the present invention, a problem of insufficient phase difference between electrodes in the pixel caused by the blue phase liquid crystals operating under an IPS mode can be solved, so as to increase transmittance of the blue phase liquid crystals.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method of a pixel, the pixel comprising a first electrode, a second electrode and a third electrode, the first electrode and the second electrode being formed on a lower substrate, the third electrode being formed on an upper substrate and above a position between the first and second electrodes, liquid crystals being formed between the upper and lower substrates, the driving method comprising:
providing a first data voltage to the first electrode;
providing a second data voltage to the second electrode; and
providing a common voltage to the third electrode;
wherein the common voltage is substantially a mean value of the first and second data voltages.

2. The driving method of claim 1 further comprising:
providing a third data voltage to the first electrode; and
providing a fourth data voltage to the second electrode;
wherein the common voltage is substantially a mean value of the third and fourth data voltages, the first and fourth data voltages are higher than the common voltage, and the second and third data voltages are lower than the common voltage.

3. The driving method of claim 2, wherein:
providing the first data voltage to the first electrode, is providing the first data voltage to the first electrode in an Nth frame;
providing the second data voltage to the second electrode, is providing the second data voltage to the second electrode in the Nth frame;
providing the third data voltage to the first electrode, is providing the third data voltage to the first electrode in an (N+1)th frame; and
providing the fourth data voltage to the second electrode, is providing the fourth data voltage to the second electrode in the (N+1)th frame;
wherein N is a positive integer.

4. A driving method of a pixel, the pixel comprising a first electrode, a second electrode and a third electrode, the first electrode and the second electrode being formed on a lower substrate, the third electrode being formed on an upper substrate and above a position between the first and second electrodes, liquid crystals being formed between the upper and lower substrates, the driving method comprising:
providing a first data voltage to the first electrode;
providing a first common voltage to the second electrode, the first common voltage being lower than the first data voltage; and
providing a first mean voltage to the third electrode, the first mean voltage being substantially a mean value of the first data voltage and the first common voltage.

5. The driving method of claim 4 further comprising:
providing a second data voltage to the first electrode;
providing a second common voltage to the second electrode, the second common voltage being higher than the second data voltage; and
providing a second mean voltage to the third electrode, the second mean voltage being substantially a mean value of the second data voltage and the second common voltage.

6. The driving method of claim 5, wherein:
providing the first data voltage to the first electrode, is providing the first data voltage to the first electrode in an Nth frame;
providing the first common voltage to the second electrode, is providing the first common voltage to the second electrode in the Nth frame;
providing the first mean voltage to the third electrode, is providing the first mean voltage to the third electrode in the Nth frame;
providing the second data voltage to the first electrode, is providing the second data voltage to the first electrode in an (N+1)th frame;
providing the second common voltage to the second electrode, is providing the second common voltage to the second electrode in the (N+1)th frame; and
providing the second mean voltage to the third electrode, is providing the second mean voltage to the third electrode in the (N+1)th frame;
wherein N is a positive integer.

7. A blue phase pixel, comprising:
an upper substrate;
a lower substrate, wherein blue phase liquid crystals are formed between the upper and lower substrates;
a first electrode, formed on the lower substrate, for providing a first data voltage in an Nth frame, and providing a third data voltage in an (N+1)th frame;
a second electrode, formed on the lower substrate, for providing a second data voltage in the Nth frame, and providing a fourth data voltage in the (N+1)th frame; and
a third electrode, formed on the upper substrate and above a position between the first and second electrodes, for providing a common voltage;
wherein the common voltage is identical in the Nth frame and the (N+1)th frame, the common voltage is substantially a mean value of the first and second data voltages, the common voltage is substantially a mean value of the third and fourth data voltages, the first and fourth data voltages are higher than the common voltage, the second and third data voltages are lower than the common voltage, and N is a positive integer.

8. The blue phase pixel of claim 7, wherein the first electrode is coupled to a first data line, the second electrode is coupled to a second data line, and the third electrode is coupled to a common voltage source.

9. The blue phase pixel of claim 7, wherein the upper substrate comprises a color filter.

10. A pixel, comprising:
an upper substrate;
a lower substrate, wherein liquid crystals are formed between the upper and lower substrates;
a first electrode, formed on the lower substrate, for providing a first data voltage in an Nth frame, and providing a second data voltage in an (N+1)th frame;
a second electrode, formed on the lower substrate, for providing a first common voltage in the Nth frame, and providing a second common voltage in the (N+1)th frame; and
a third electrode, formed on the upper substrate and above a position between the first and second electrodes, for providing a first mean voltage substantially equal to a mean value of the first data voltage and the first common voltage in the Nth frame, and providing a second mean voltage substantially equal to a mean value of the second data voltage and the second common voltage in the (N+1)th frame;
wherein the first common voltage is lower than the first data voltage, the second common voltage is higher than the second data voltage, and N is a positive integer.

11. The pixel of claim 10, wherein:
the first electrode is coupled to a first data line; and
the second electrode is coupled to a first common voltage source providing the first common voltage, and coupled to a second common voltage source providing the second common voltage in a sequence.

12. The pixel of claim 10, wherein the upper substrate comprises a color filter.
